(19) United States
(12) Patent Application Publication
(10) Pub. No.: US 2017/0199549 A1
(43) Pub. Date: Jul. 13, 2017

(54) FLEXIBLE ELECTRONIC DEVICE

(71) Applicant: Lenovo (Beijing) Limited, Beijing (CN)

(72) Inventor: Jihun Yeom, Beijing (CN)

(21) Appl. No.: 15/403,909

(22) Filed: Jan. 11, 2017

(30) Foreign Application Priority Data
Jan. 11, 2016 (CN) 201610015754.3
Jan. 11, 2016 (CN) 201610015848.0

(51) Int. Cl. G06F 1/16

(52) U.S. Cl. CPC G06F 1/1652

(57) ABSTRACT

A device is disclosed. The device includes a flexible display screen that includes a first surface that is a display output region. An external force is exerted on the flexible display screen. In a deformation of a first variation curve, the two display regions divided by a first variation region face each other. In a deformation of a second variation curve, the two display regions divided by a second variation region face away from each other. The deformation state in which the flexible display screen has the deformation of the first variation curve is unchanged after the external force is no longer exerted. The deformation state in which the flexible display screen has the deformation of the second variation curve is unchanged after the external force is no longer exerted.

### FIELD

The present application relates to the field of electronic technologies, and in particular, to a flexible electronic device.

### BACKGROUND

With the continuous development of science and technology, various electronic devices with flexible display screens are being developed, such as smart phones, tablet computers and smart bracelets. In such devices using conventional technology, flexible display screens of electronic devices are restricted in the manners in which they can be bent and used.

### SUMMARY

A device is disclosed.

The device comprises a flexible display screen, comprising a first surface, the first surface being a display output region of the flexible display screen; wherein an external force is exerted on the flexible display screen, the flexible display screen generates a deformation of a first variation curve at a first variation region as a result of the external force orienting two display regions of the flexible display screen that are partitioned by the first variation region to face each other, the flexible display screen generates a deformation of a second variation curve at a second variation region as a result of the external force orienting two display regions of the flexible display screen that are partitioned by the second variation region to face away from each other, the deformation state in which the flexible display screen has the deformation of the first variation curve is unchanged after the external force is no longer exerted, and the deformation state in which the flexible display screen has the deformation of the second variation curve is unchanged after the external force is no longer exerted.

### BRIEF DESCRIPTION OF THE DRAWINGS

To describe the disclosed technical solutions more clearly, accompanying drawings used for describing the embodiments are hereinafter briefly introduced. It is apparent that the accompanying drawings hereinafter are only intended to illustrate some embodiments of the present application.

FIG. 1 is a schematic view showing the structure of one embodiment of a flexible electronic device;

FIGS. 2A to 2B are schematic views of one embodiment of a flexible display screen of a flexible electronic device;

FIGS. 3A to 3B are schematic views of a first variation region and a second variation region 103 of one embodiment of a flexible electronic being deformed by the action of an external force;

FIG. 4 is a schematic view showing one embodiment of a first implementation of a flexible electronic device in a first deformation mode;

FIG. 5 is a schematic view showing one embodiment of a second implementation of a flexible electronic device in the first deformation mode;

FIG. 6 is a schematic view showing one embodiment of a third implementation of a flexible electronic device in the first deformation mode;

FIGS. 7A to 7B are schematic views showing the positions where a first variation region and a second variation region 103 of one embodiment of a flexible electronic device are located;

FIGS. 8A to 8G are schematic views showing the structure of one embodiment of a flexible electronic device further including a device body;

FIGS. 8H to 8U are schematic views showing variation states, in which a flexible display screen is deformed, of one embodiment of a flexible electronic device wherein a device body is included;

FIG. 9 is a schematic view showing the structure of a flexible support apparatus in one embodiment of a flexible electronic device;

FIGS. 10A to 10B are schematic views of positions for arranging a flexible support apparatus in embodiments of a flexible electronic device;

FIG. 11 is a schematic structural view of the structure in FIG. 9 in a bent state;

FIG. 12 is a schematic structural view of the structure in FIG. 11 at a maximum degree of bending;

FIGS. 13A to 13C are schematic views showing the structure of a first connecting member in various embodiments;

FIG. 14 is a schematic view showing the structure of a second connecting member of one embodiment;

FIG. 15 is a schematic view showing another structure of the second connecting member of one embodiment;

FIG. 16 is a schematic view showing yet another structure of the second connecting member of one embodiment;

FIGS. 17 to 18 are schematic views showing the structure of a third connecting member of various embodiments;

FIGS. 19 to 21 are schematic views showing the structure of a fourth connecting member of various embodiments;

FIG. 22 is a schematic view showing the assembly of the first connecting member, the second connecting number, the third connecting member, the fourth connecting member, a filling block, and sliding shafts of one embodiment;

FIG. 23 is a schematic view showing the structure of a filling block of one embodiment;

FIG. 24 is a schematic view showing the structure of a sheet-like third connecting member of one embodiment;

FIG. 25 is a schematic view showing the structure of a sheet-like fourth connecting member of one embodiment;

FIG. 26 is a schematic view showing the structure of a sheet-like filling block of one embodiment;

FIG. 27 is a schematic front view showing the structure of a first connecting member of one embodiment manufactured by stamping, cutting and curling;

FIG. 28 is a perspective view of the structure in FIG. 27;

FIG. 29 is a schematic front view showing the structure of a second connecting member of one embodiment manufactured by stamping, cutting and curling;

FIG. 30 is a perspective view of the structure in FIG. 29;

FIG. 31 is a schematic front view showing the structure of a first member portion of one embodiment;

FIG. 32 is a schematic perspective view showing the structure of the first member portion shown in FIG. 31;

FIG. 33 is a schematic front view showing the structure of a second member portion of one embodiment;

FIG. 34 is a schematic perspective view showing the structure of the first member portion shown in FIG. 33;

FIG. 35 is a schematic front view showing the structure of a third member portion of one embodiment;

FIG. 36 is a schematic perspective view showing the structure of the third member portion in FIG. 35;

FIG. 37 is a schematic front view showing the structure of a fourth member portion of one embodiment;

FIG. 38 is a schematic perspective view showing the structure of the fourth member portion in FIG. 37;

FIG. 39 is a schematic view showing the structure of a first fixed connection piece of one embodiment; and

FIG. 40 is a schematic view showing the structure of a second fixed connection piece of one embodiment.

### DETAILED DESCRIPTION

The technical solutions described herein are for addressing the technical issue of limited manners in which a flexible display screen of an electronic can be bent, and to provide enhanced manners of bending.

In order to address the foregoing technical issue, the general idea of the embodiments is as follows. A flexible electronic device includes a flexible display screen including a first surface which is a display output region of the flexible display screen. Specifically, the flexible display screen generates a deformation of a first variation curve at a first variation region as a result of an external force, which allows two display regions of the flexible display screen partitioned by the first variation region to face each other, as well as a deformation state in which the flexible display screen having the deformation of the first variation curve is kept unchanged after the external force is canceled.

Also, the flexible display screen generates a deformation of a second variation curve at a second variation region 103 as a result of the action of an external force to allow two display regions of the flexible display screen partitioned by the second variation region 103 to face away from each other, as well as a deformation state in which the flexible display screen has the deformation of the second variation curve is kept unchanged after the external force is canceled.

Thus, the embodiments, unlike in the conventional technology where a flexible display screen of an electronic device can only be bent in limited manners, such as bending inwards or bending outwards, the manners of bending in the embodiments are enhanced and expanded. In the embodiments, the deformation of the first variation curve can be generated on the first variation region, to allow the two display regions of the flexible display screen partitioned by the first variation region to face each other. Also, the flexible display screen can generate a deformation of the second variation curve on the second variation region 103 by the action of an external force to allow the two display regions of the flexible display screen partitioned by the second variation region 103 to face away from each other. The embodiments thus providing enhanced manners of bending, and the technical issue of limited manners of bending of the flexible display screen of the electronic device can be effectively addressed.

To better understand the above technical solution, various embodiments are described in detail with reference to the accompanying drawings. It should be understood that the embodiments and the specific features in the embodiments are exemplary descriptions, rather than limitations of the scope of the embodiments. Furthermore, the embodiments and the technical features found in the embodiments may be combined together so long as they do not conflict with each other.

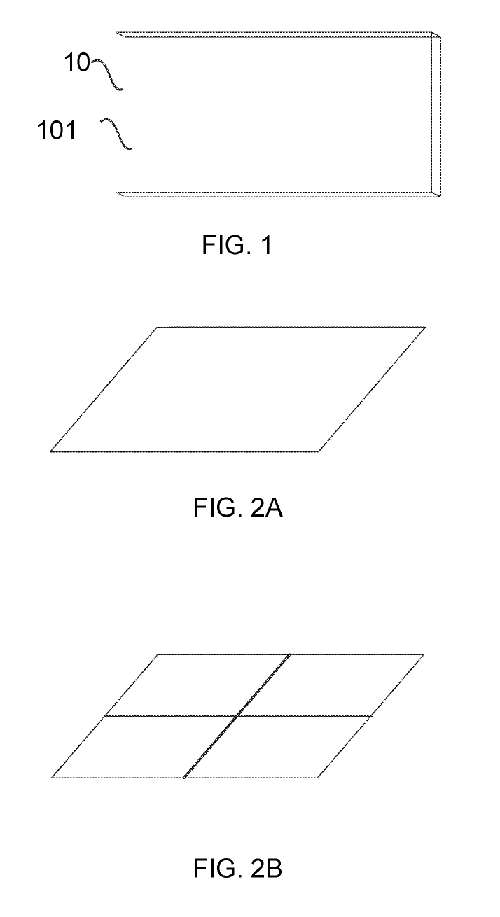

Reference is made to FIG. 1, which is a schematic view showing the structure of one embodiment of a flexible electronic device. The flexible electronic device is described in detail hereinafter.

A flexible display screen 10 includes a first surface 101 which is a display output region of the flexible display screen 10.

Specifically, the flexible display screen 10 generates a deformation of a first variation curve at a first variation region as a result of an external force, to allow two display regions of the flexible display screen 10 partitioned by the first variation region to face each other, and a deformation state in which the flexible display screen 10 has the deformation of the first variation curve is kept unchanged after the external force is canceled.

The flexible display screen 10 generates a deformation of a second variation curve at a second variation region 103 by the action of an external force, to allow two display regions of the flexible display screen 10 partitioned by the second variation region 103 to face away from each other and a deformation state in which the flexible display screen 10 has the deformation of the second variation curve is kept unchanged after the external force is canceled.

In the embodiment of the present application, the flexible electronic device may be a smart cellphone, a tablet computer, a personal digital assistant, a navigator or other electronic device having the flexible display screen 10. The embodiments are not limited to these devices; they serve only as examples.

In this embodiment, the flexible display screen 10 is made of a soft material, such as a flexible glass, and is a display device which is deformable and bendable. When a user of the flexible electronic device does not need to use the flexible electronic device, he may curve or bend the flexible display screen 10, reducing the volume of the flexible display screen 10 and making the device convenient to carry. When the user needs to use the flexible display screen, he may expand the flexible display screen 10 to provide a large display screen and offer a good viewing experience to the user. Furthermore, the flexible glass can also be implemented on various substrates, such as a plastic substrate, a metal substrate or a paper substrate, and after a power supply is turned off, the image located on the flexible display screen 10 can be maintained and displayed.

In some embodiments, the flexible display screen 10 includes a first surface 101 which is a display output region of the flexible display screen 10, and the display output region may be an independent display output region, and may also be multiple independent display output regions. For example, the flexible display screen 10 may be divided into four independent display output regions arranged up and down and left and right, and the each display output region is independent from the other (see FIGS. 2A and 2B). If the display output region comprises multiple independent display output regions, when one of the output regions is operated, other output regions will not be interfered with, and the operation result will not be displayed on other display output regions, thus facilitating operation of the flexible electronic device by multiple users, and offering a good user experience.

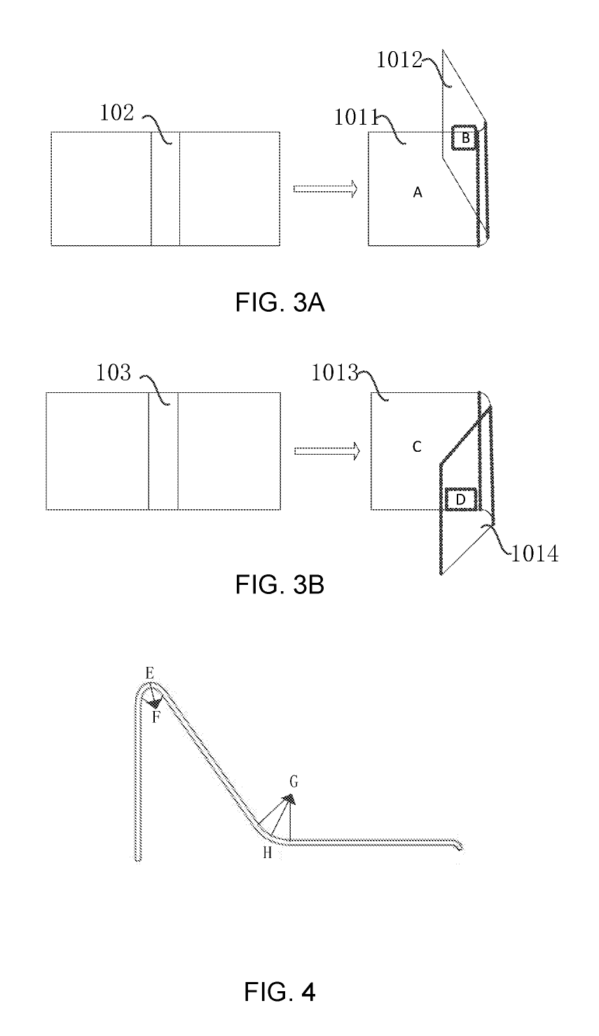

In one embodiment, referring to FIG. 3A, a first variation region 102 of the flexible display screen 10 generates a deformation by the action of an external force, to partition the flexible display screen 10 into a display region A and a display region B, using the first variation region 102 as a common region, and the display region A and the display region B are oriented as to face each other. Specifically, if taking a first sub-surface 1011, corresponding to the display region A, on the first surface 101 as a reference surface, the display region A and the display region B face each other. There is also a second sub-surface 1012, corresponding to the display region B, on the first surface 101 that faces towards the first sub-surface, and the flexible display screen 10 can be kept unchanged after the external force applied on the first variation region 102 is canceled.

In one embodiment, referring to FIG. 3B, a second variation region 103 on the flexible display screen 10 generates a deformation as a result of the action of an external force, to partition the flexible display screen 10 into a display region C and a display region D, using the second variation region 103 as a common region, and the display region C and the display region D face away from each other. Specifically, if taking a third sub-surface 1013, corresponding to the display region C, on the first surface 101 as a reference surface, the display region C and the display region D face away from each other, which means that the fourth sub-surface 1014, corresponding to the display region D, on the first surface 101 and the third sub-surface 1013 face away from each other. In some specific implementations, the flexible display screen 10 can be kept unchanged after an external force applied on the second variation region 103 is canceled.

In one embodiment of the present application, the first variation region and the second variation region 103 are involved in at least the following two cases.

In a first case, the first variation region 102 and the second variation region 103 are each specifically a region having a certain width, which can vary between embodiments. In different implementations, the width of the first variation region 102 and the width of the second variation region 103 may be the same or different, and may be set by those skilled in the art according to practical requirements. The specific widths are not limited to widths specified in this embodiments.

In a second case, when the first variation region 102 and the second variation region 103 have sufficiently narrow widths, the first variation region 102 and the second variation region 103 comprise folding lines. In one specific implementation, the first variation region 102 is a region having a certain width, and the second variation region 103 is a folding line. In another implementation, the first variation region 102 is a folding line, and the second variation region 103 is a region having a certain width. Those skilled in the art can set the widths according to practical requirements, which are not limited by the embodiments.

Further, in another embodiment of the present application, the first variation region 102 and the second variation region 103 may be different variation regions, and may also be the same variation region, the two cases are described respectively hereinafter.

In a first case, the first variation region 102 and the second variation region 103 comprise different variation regions.

In one embodiment of the present application, the first variation region 102 and the second variation region 103 are not coincident with each other. The two display regions of the flexible display screen 10 partitioned by the first variation region 102 are a first display region and a second display region, and the two display regions of the flexible display screen 10 partitioned by the second variation region 103 are the second display region and a third display region.

In a specific implementation, referring to FIG. 4, in the case where the first variation region 102 and the second variation region 103 are not coincident with each other, the first variation region 102 partitions the flexible display screen 10 into two display regions, a first display region and a second display region, using the first variation region 102 as a common region, and the first display region and the second display region face each other, that is, the flexible display screen 10 is bent inwards on the first variation region 102. The second variation region 103 is on a display region other than the first display region of the flexible display screen 10 and partitions the flexible display screen 10 into two display regions, the second display region and a third display region, using the second variation region 103 as a common region. That is, the flexible display screen 10 is bent outwards on the second variation region 103.

In a specific implementation, the first display region, the second display region and the third display region may be display regions independent from each other, and may also be a large display region formed by splicing. Furthermore, the first display region, the second display region and the third display region may display the same display content. They may also display different display contents, which may be set by those skilled in the art according to practical requirements, and is not limited by the embodiments.

In one embodiment of the present application, a part, corresponding to the first display region of the flexible display screen 10, is a first part, and another part, corresponding to the second display region of the flexible display screen 10, is a second part, and yet another part, corresponding to the third display region of the flexible display screen 10, is a third part.

Specifically, the first part is located on a first side of a plane where the second part is located, and the third part is located on a second side opposite to the first side of the plane where the second part is located.

In one specific implementation, referring to FIG. 4, a part corresponding to the first display region of the flexible display screen 10 functions as a first part of the flexible display screen 10, and a part corresponding to the second display region of the flexible display screen 10 functions as a second part of the flexible display screen 10, and a part corresponding to the third display region, of the flexible display screen 10 functions as a third part of the flexible display screen 10. As shown in FIG. 4, the first part is located on a first side of a plane where the second part is located, and the third part is located on a second side opposite to the first side of the plane where the second part is located. That is, the flexible display screen 10 is bent inwards, and is also bent outwards.

The first variation curve has a shape different from that of the second variation curve, and the third part functions as a support piece.

In one specific implementation, referring to FIG. 4, in the case where the first variation region 102 and the second variation region 103 are regions having a certain width, the first variation region 102 and the second variation region 103 are each deformed when being applied thereon with an external force, each forming an arc having a certain arc measure, thus forming the first variation curve and the second variation curve correspondingly. In one embodiment, the first variation curve is a first arc-shaped curve having a first arc measure, and the second variation curve is a second arc-shaped curve having a second arc measure. Further, in one embodiment, an opening direction of the first arc-shaped curve is a first direction that is the direction oriented from a point E to a point F is the first direction, the point E being a tangent point of an external tangent line of the first variation curve, and the point F is an intersection point if making radials from two ends of the first variation curve. An opening direction of the second arc-shaped curve is a second direction that is the direction oriented from a point G to a point H is a second direction, the point G is a tangent point of an external tangent line of the second variation curve, and the point H is an intersection point if making radials from two ends of the second variation curve.

In one embodiment, the first variation curve has a shape different from that of the second variation curve, which is mainly demonstrated by the fact that the are measure corresponding to the first variation curve and the second variation curve are different. For example, the first variation curve may comprise a first arc-shaped curve having a radius of π/6, and the second variation curve may comprise a second arc-shaped curve having a radian of π/3. In other embodiments, the first variation curve may comprise a first arc-shaped curve having a radian of π/4, and the second variation curve may comprise a second arc-shaped curve having a radian of π/3. The first variation curve and the second variation curve may also form arc-shaped curves having other arc measures, which are not specifically limited by the embodiments described herein. In one embodiment of the present application, the shapes of the first variation curve and the second variation curve being different is further demonstrated in that opening directions of the first variation curve and the second variation curve are different.

In one embodiment of the present application, the first display region and the second display region face each other, and thus the first portion and the second portion also face each other. Also, in the same embodiment, the second display region and the third display region face away from each other, and thus the second part and the third part also face away from each other. In a practical application, if a side where a user stands is taken as a reference side, the first part and the second part face towards the user, and then the third part is opposite to the user. In such a case, the first part and the second part may function as an input region or a display region, and the third part may function as a support piece for the second part, to ensure the stability of the electronic device, and facilitate operation of the electronic device by the user.

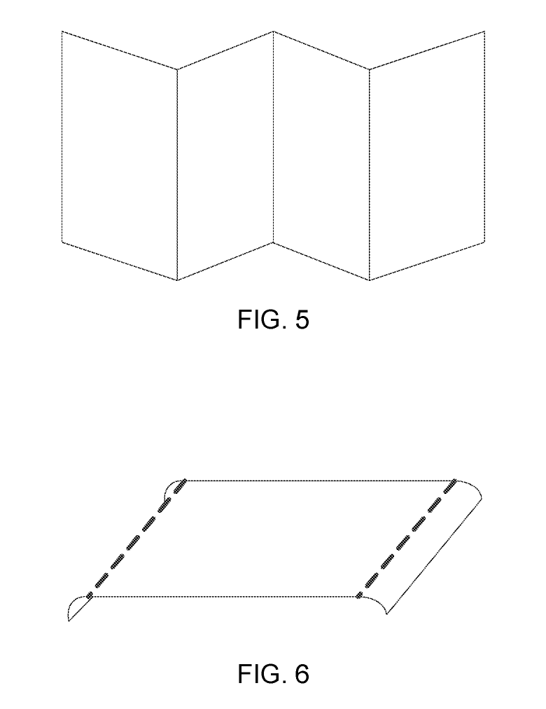

In one embodiment of the present application, other than bending the electronic device inward once and outward once, those skilled in the art may further fold the flexible display screen 10 inwards and outwards according to practical requirements, which may include, for example, folding the flexible display screen into a “W” shape, or bending the flexible display screen more times, to bend the flexible display screen 10 into a wave shape, so as to have multiple folded portions. Reference may be made to FIG. 5 for specific details of one example.

In one embodiment of the present application, the flexible electronic device may further be bent outwards multiple times, such as a case wherein two ends of the flexible display screen 10 are bent outwards. In this way, an outward bent part may function as a handle for the flexible electronic device to facilitate handling by the user. In another aspect, the outward bent part may further function as a support piece for supporting a planar part of the flexible display screen 10 to facilitate watching videos or listening to music. In this way, there is no need for the user to always grip the flexible electronic device, thus offering a good user experience. Reference may be made to FIG. 6 for specific details of one example.

In a second case, the first variation region and the second variation region 103 comprise the same variation region.

In an example of one embodiment wherein an initial state of the flexible display screen 10 is an unbent state, a first surface 101 of the flexible display screen 10 faces upwards. Thus, when an external force is applied on the first variation region of the flexible display screen 10, the flexible display screen 10 generates a deformation of a first variation curve on the first variation region by the action of the external force, to allow two display regions of the flexible display screen 10 partitioned by the first variation region to face each other. In this way, the second sub-surface, corresponding to the second display region, on the first surface 101 faces towards the first sub-surface, corresponding to the first display region on the first surface 101. The flexible electronic device in the current state may be in a laptop form, a folded state or in other states in which the first sub-surface and the second sub-surface have an angle ranging from 0 degree to 180 degrees therebetween.

In one specific implementation, wherein the first variation region and the second variation region 103 are the same variation region, an external force may further be applied to the first variation region. In such a case, the flexible display screen 10 generates a deformation of a second variation curve on the first variation region by the action of the external force to allow two display regions of the flexible display screen 10 partitioned by the first variation region to face away from each other. In this way, the second sub-surface, corresponding to the second display region, on the first surface 101 is opposite the first sub-surface corresponding to the first display region on the first surface 101 and the flexible electronic device may be currently in a small tablet computer state, a tent state or other states.

Further, in another embodiment, the first variation region is not fixed; and the second variation region 103 is not fixed.

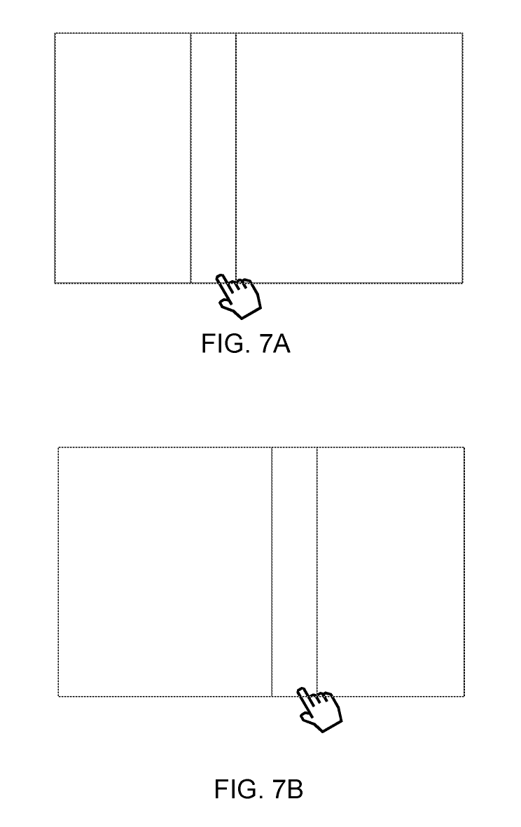

In one specific implementation, wherein the first variation region and the second variation region 103 are the same variation region or are different variation regions, the first variation region and the second variation region 103 may each be a non-fixed region. That is, the first variation region and the second variation region 103 may change as a point on which an external force is applied changes. For example, when the point on which an external force is applied is at one-third of the way across, in a transverse direction, of the flexible display screen 10, the first variation region is at one-third, in the transverse direction, of the flexible display screen 10. When the point at which an external force is applied is at two-thirds, in the transverse direction, of the flexible display screen 10, the first variation region is at two-thirds, in the transverse direction, of the flexible display screen 10. When the point on which an external force is applied is at one-third, in a longitudinal direction, of the flexible display screen 10, the first variation region is at one-third, in the longitudinal direction, of the flexible display screen 10; correspondingly, the second variation region 103 may be located on two-thirds, in the transverse direction of the flexible display screen 10 as the position of the point on which an external force is applied changes. For examples including the one-third, in the transverse direction, of the flexible display screen 10 and the two-thirds, in the longitudinal direction, of the flexible display screen 10, reference may be made to FIGS. 7A to 7B.

In one embodiment of the present application, the flexible display screen 10 has an unbent mode and a first deformation mode. Specifically, the first deformation mode is a mode in which the flexible display screen 10 generates a deformation of a first variation curve at a first variation region by the action of an external force to allow two display regions of the flexible display screen 10 partitioned by the first variation region to face each other, and a deformation state in which the flexible display screen has the deformation of the first variation curve, and it is kept unchanged after the external force is canceled. The flexible display screen 10 also generates a deformation of a second variation curve at a second variation region 103 by the action of an external force to allow two display regions of the flexible display screen 10 partitioned by the second variation region 103 to face away from each other, and a deformation state in which the flexible display screen 10 has the deformation of the second variation curve and is kept unchanged after the external force is canceled. Specifically, in this example, the first variation region and the second variation region 103 are not coincident with each other. The two display regions of the flexible display screen 10 partitioned by the first variation region comprise a first display region and a second display region; and the two display regions of the flexible display screen 10 partitioned by the second variation region 103 comprise the second display region and a third display region.

In one embodiment of the present application, the flexible display screen 10 has two modes. For example, these modes may comprise an unbent mode and a first deformation mode.

In a specific implementation, the unbent mode of the flexible electronic device is a mode in which the first part, the second part and the third part of the flexible electronic device are located on the same horizontal plane.

In a specific implementation, in addition to the unbent mode, the flexible electronic device further has a first deformation state. Reference may be made to FIG. 4. In one embodiment, after the first variation region on the flexible display screen 10 is deformed by the action of an external force, two display regions into which the flexible display screen 10 is partitioned, using the first variation region as a common region face each other, and the two display regions comprise a first display region and a second display region. Specifically, if a first sub-surface, corresponding to the first display region, on the first surface 101 is used as a reference surface, the first display region and the second display region face each other, and the second sub-surface, corresponding to the second display region, on the first surface 101 faces towards the first sub-surface. Then, after the second variation region 103 on the second display region on the flexible display screen 10 is deformed by the action of an external force, a part, corresponding to the second display region of the flexible display screen 10, is partitioned into the second display region and a third display region taking the second variation region 103 as a common region, and the second display region and the third display region face away from each other. Specifically, the third display region and the second display region facing away from each other means that a third sub-surface, corresponding to the third display region on the first surface 101, is opposite to the second sub-surface, thus allowing the flexible electronic device to be in the first deformation mode that, in some embodiments, comprises a laptop mode.

In a specific implementation, when the external forces applied on the first variation region and the second variation region 103 are canceled, the flexible display screen 10 can be maintained in the deformed state until an external force acts on the flexible display screen 10 further, to allow the user of the electronic device to operate the flexible electronic device in a different mode desired by the user.

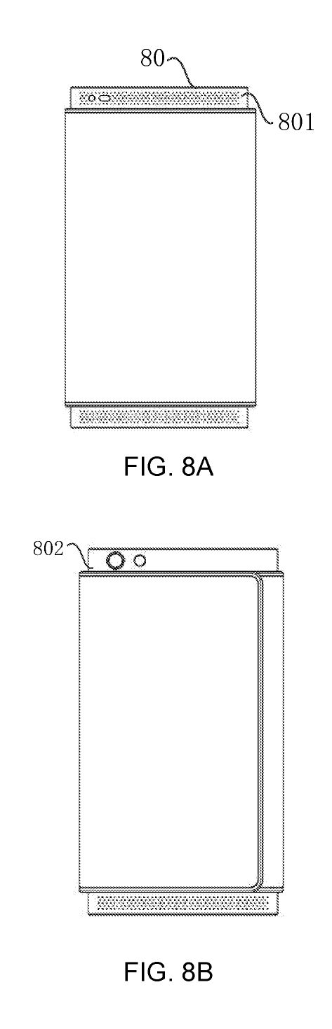

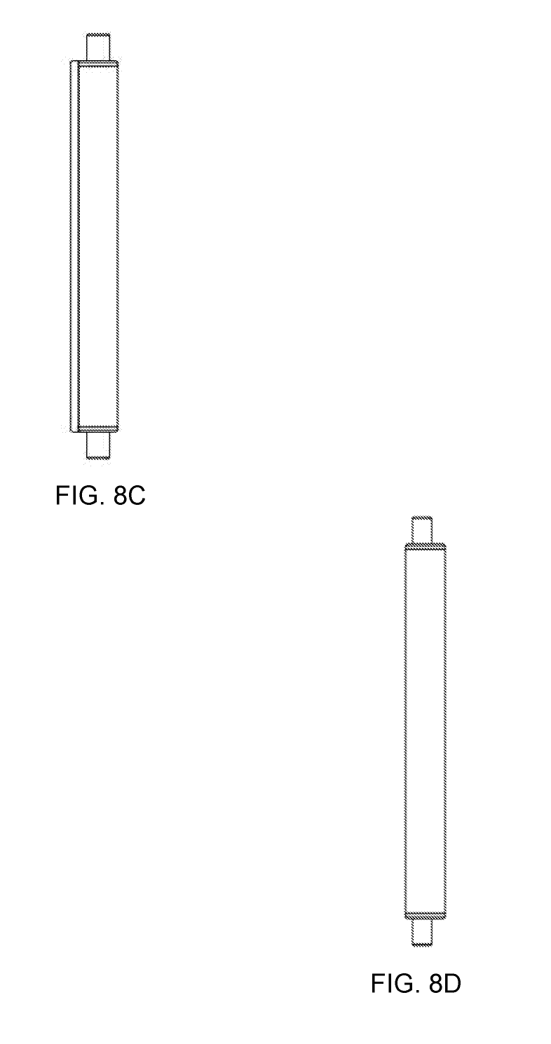

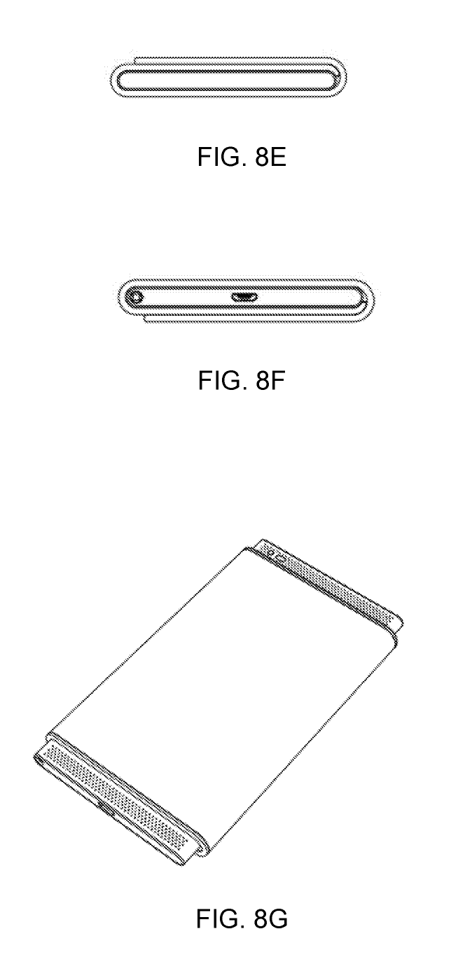

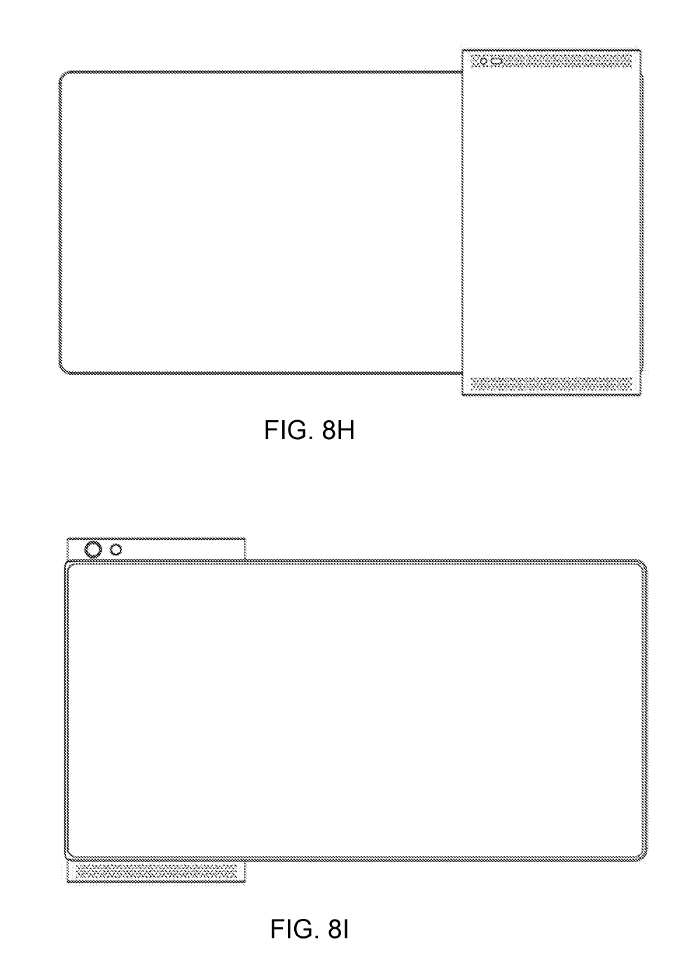

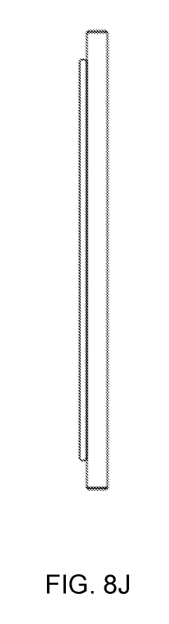

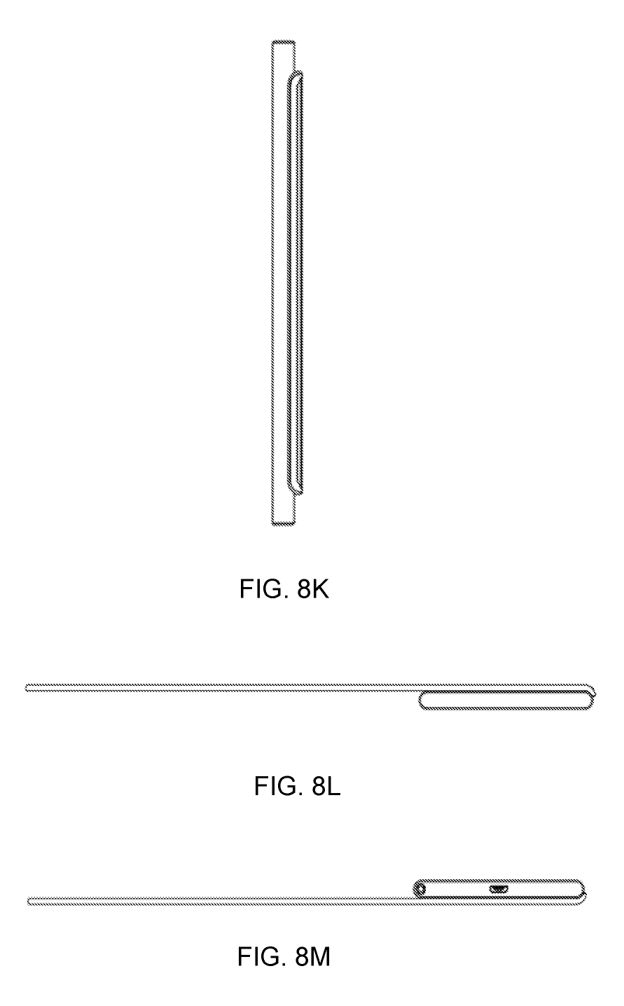

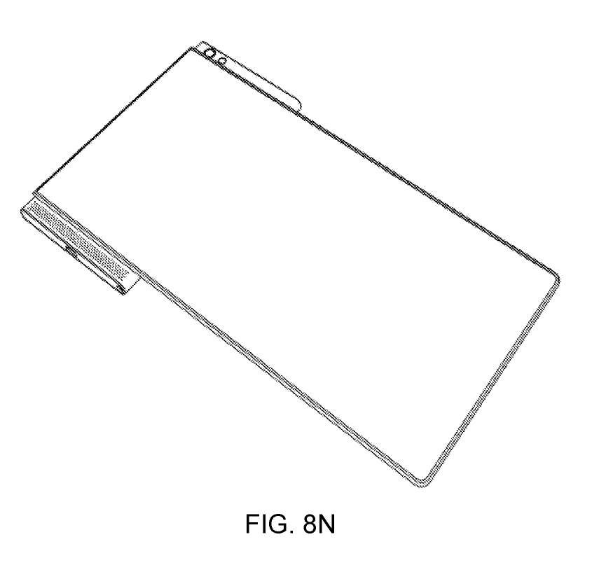

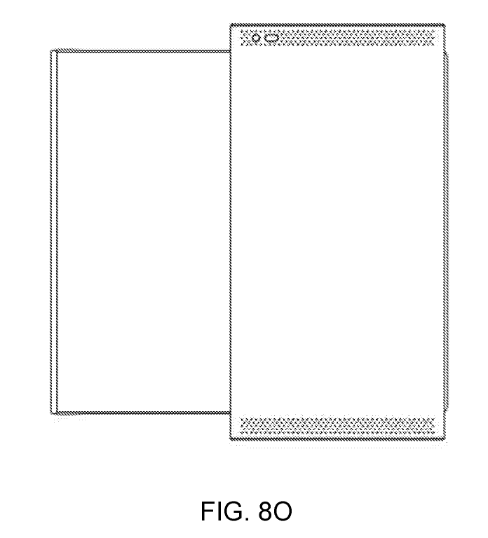

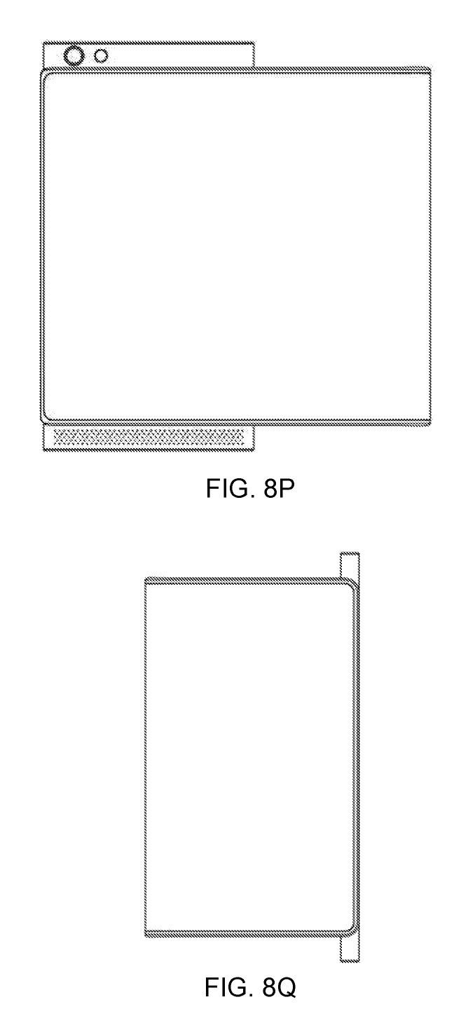

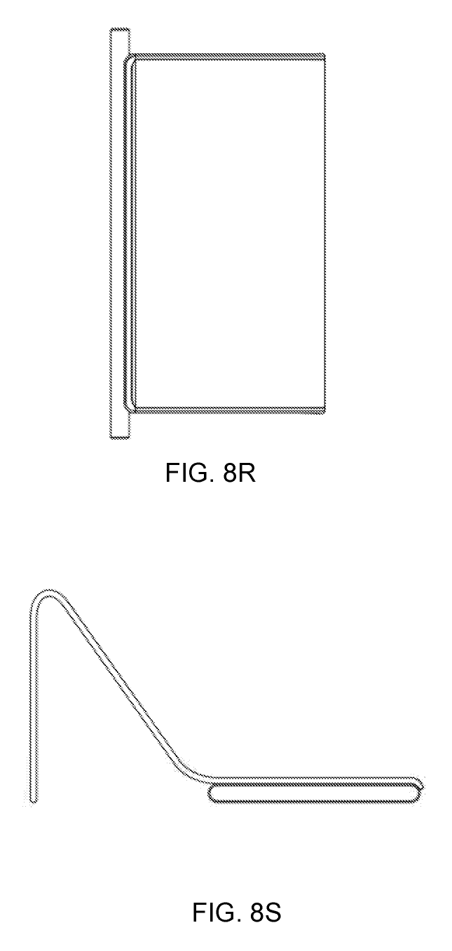

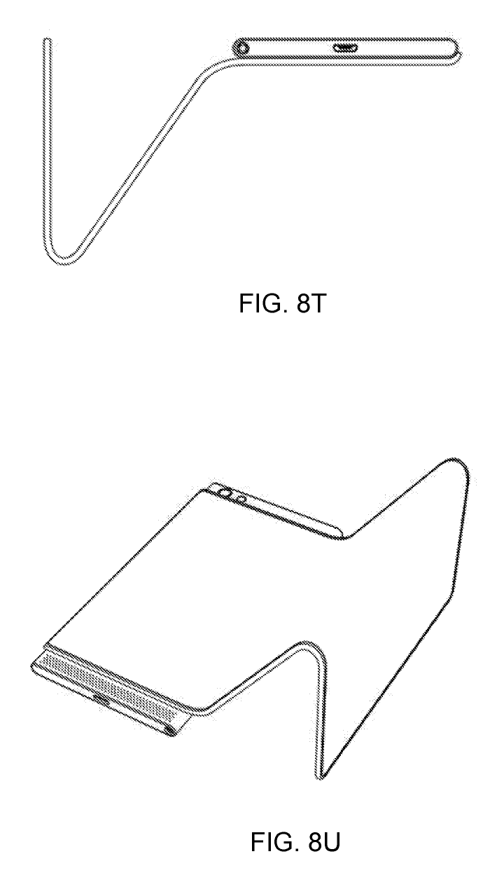

Furthermore, in another embodiment, referring to FIGS. 8A to 8G, the flexible electronic device further includes a device body 80, fixedly connected to the first part of the flexible display screen 10. The flexible display screen 10 further includes a second deformation mode, which is a mode in which the flexible display screen 10 is deformed flexibly about the device body 80.

In one embodiment, the device body 80 includes a front housing 801 and a rear housing 802, and various electronic elements can be installed in a space defined by the front housing 801 and the rear housing 802, and at least one middle housing may further be additionally provided between the front housing 801 and the rear housing 802.

In a specific implementation, the first part of the flexible display screen 10 is connected to the device body 80 and functions as a display module of the flexible electronic device. In one embodiment, a touch panel is overlapped with the display module to thus form a layered structure, and hence the display module can be used as a touch panel. Therefore, information of various types can be inputted into the mobile terminal simply by touching the display module. Further, an audio frequency output module, such as an earpiece or a speaker, can be further provided at an upper end portion of the front housing 801 of the device body 80. Also, an image acquisition unit, such as a first camera configured to take static or dynamic images of a user, may further be provided. Reference may be made to FIG. 8A for specific details.

In a specific implementation, an image acquisition unit, for example, a second camera, may further be provided at an upper end portion of the rear housing 802 of the device body 80. The first camera and the second camera are respectively configured to shoot objects in different directions. In addition, the first camera and the second camera may have different resolutions. In one example, before the flexible electronic device focuses, when determining whether there is a target object in a shot range first, the camera with a low resolution is first started, and when it is determined that there is a target object in the shot range, the camera with a high resolution is then started, thus lowering power consumption of the flexible electronic device. Further, a light supplement lamp may further be provided on the upper end portion of the rear housing of the device body 80, thus offering better shooting to the user (reference may be made to FIG. 8B). Of course, in different embodiments, the electronic elements listed above may be arranged in an accommodating space defined by the front housing 801 and the rear housing 802, and may also be arranged in the flexible display screen 10. The arrangements are not limited to these specific examples.

Furthermore, in one embodiment, according to specific design requirements, the device body 80 may have a cylindrical shape, an elliptical shape, a prism shape or other shapes. The possible shapes are not limited to the aforementioned shapes. Similarly, after the shape of the device body 80 is determined, the flexible display screen 10 may be folded according to the specific shape of the device body 80. That is, it may be in a particular mode after being deformed about the device body 80.

In a specific implementation, when the surface of the device body 80 connected to the first part has a length×width of 14 cm×7 cm, if the flexible display screen 10 has a length×width of 12 cm×7 cm, the flexible display screen 10 can just cover the front housing 801 of the device body 80. If the flexible display screen 10 has a length×width of 12 cm×16 cm, the flexible display screen 10 can just cover the front housing 801 and the rear housing 802 of the device body 80 and a left side surface and a right side surface of the device body 80. If the flexible display screen 10 has a length×width of 12 cm×23 cm, the flexible display screen 10 can not only cover the front housing 801, the rear housing 802 of the device body 80 and the left side surface and the right side surface of the device body 80, but also can be stacked on the front housing 801 of the device body 80. Reference may be made to FIGS. 8B to 8G, which are, specifically, a rear view, a left view, a right view, a top view, a bottom view, and a perspective view of a first deformation mode. The covering manner of the flexible display screen 10 may be designed according to the shape of the device body 80 and the specific dimension of the flexible display screen 10, which is not specifically limited in the embodiments of the present application.

In a specific implementation, when the flexible display screen 10 is in the second deformation mode, if a user is using the flexible electronic device for, as examples, watching videos, visiting websites, or looking at photos taken with the flexible electronic device, the user may unbend the flexible display screen 10 from the device body 80, thus performing the above operations by using the large screen, which offers a good user experience. In addition, in some cases, if the user desires, the flexible electronic device can be used in a laptop mode. In this case, the flexible display screen 10 may be unbent from the device body 80, and the first part and the second part are bent inwards and outwards to allow the flexible electronic device with the device body 80 to be in a laptop mode, and the third part can be used to support the second part to facilitate operating by the user on the second display region corresponding to the second part, thus offering a good user experience. For schematic views showing variation states of the flexible display screen 10, reference may be made to FIGS. 8H to 8U.

Furthermore, in one embodiment, the flexible electronic device further includes: a processor configured to acquire mode information of the flexible display screen 10 and determine the display of to-be-displayed contents on the three regions and/or the variation regions of the flexible display screen 10 according to the mode information of the flexible display screen 10.

To provide a better user experience, in one specific implementation, a gravity sensor or a spatial sensor may be respectively provided at each of the upper and lower ends or each of left and right ends of the flexible display screen 10, to determine whether the flexible display screen 10 is bent through the gravity variation of the flexible display screen 10. An angular sensor may also be provided at each of the upper and lower ends or each of the left and right ends of the display screen. Thus, when the angle of the display screen varies, the angular sensors can detect the variation to thereby send the parameter information acquired to the processor of the flexible electronic device.

After the processor receives the parameter information of the sensors, it can determine the current deformation state, such as the unbent state, the first deformation mode or the second deformation mode of the flexible electronic device according to the parameter information received, and further determine the display of the to-be-displayed contents on the three regions and/or the variation regions of the flexible display screen 10 according to the deformation mode of the flexible electronic device.

In one embodiment, the processor may be arranged in the flexible display screen 10. In other embodiments, it may also be arranged in the device body 80, which can be set according to practical requirements by those skilled in the art, and is not specifically limited by the examples given in the embodiments described herein.

The manners of display of the flexible electronic device in different forms are respectively described hereinafter.

The display manner of the flexible electronic device in the second deformation mode is described as follows.

In a specific implementation, when the flexible electronic device is in the second deformation mode, such as a cellphone mode, the three display regions may function as a main display region, and the variation region may function as an additional display region. For example, the main display region may be utilized to display an interface related to a program, and the additional display region is utilized to display an interface related to another program. In one example, the main display region is utilized to display a document processing program to display, for example, a pdf document, a word document or a ppt document, and the additional display region is utilized to display a music playing program, to allow the user to listen and control the playing of the music while reading the document without requiring leaving the document processing program displayed on the main display region to control the music playing, which control can include switching other music, controlling the playing procedure, or other operations, thus achieving real multi-task simultaneously handling.

The display manner of the flexible electronic device in the unbent state is described as follows.

In the case where the flexible electronic device is in the unbent state, for example, in a tablet computer mode, the first part, the second part and the third part of the flexible electronic device 10 are located on the same plane. In this way, if the user operates the flexible electronic device as a game machine, the first display region and the second display region respectively corresponding to the first part connected to the device body 80 and a second part adjacent to the first part may be taken as a main display region of the flexible electronic device, and the third display region corresponding to the third part may be taken as an additional display region of the flexible electronic device, thus the images of the game may be displayed on the main display screen, and related operation buttons may be displayed on the additional display region, and the user may input commands through the operation buttons to perform game control. In this way, the user may enlarge the region for displaying game pictures to a maximum degree without occupying the main display region of the device, to improve the visual experience of the user.

Of course, the additional display region may also be utilized to display other information. For example, if a user receives a short massage when playing games, he may utilize the additional display region to display the short message received. The message can be displayed by other manners which can be set according to practical requirements by those skilled in the art.

The display manner of the flexible electronic device in the first deformation mode is described as follows.

In some embodiments, and in the case wherein the flexible electronic device is in a first deformation mode, the flexible electronic device may specifically have the following two cases.

A first case is that the flexible electronic device is in a laptop mode.

In a specific implementation, in the case where the flexible electronic device is in the laptop mode, the first part may function as an input region, and the second part and the third part may function as display regions, also the third part functions as a support piece for the second part, to ensure stability of the second part. In this embodiment, the second display region corresponding to the second part and the third display region corresponding to the third part may display the same content, to ensure that users at different locations can see the same content. However, the second display region and the third display region may also display different contents. For example, applications for business can be displayed on the second display region, and an entertainment application may be displayed on the third display region. The above two display manners may be set by those skilled in the art according to practical requirements, which are not limited to the examples described herein.

In a second case, the first part forms a plane, and the second part and the third part form a camber, to function as a handle of a game machine, thus facilitating operation by the user. Further, when a user uses the flexible electronic device not in this configuration to play a video, if the flexible electronic device is gripped for a long time, heat dissipation is impeded and the user may feel tired. In this case, the camber formed by the third part may function as a support piece to have the flexible electronic device placed stably on the table, to allow the user to watch for a long time, or to allow more people to watch.

In a specific implementation, the flexible display screen 10 may be switched between the above three modes during use. During switching, the first part and the second part of the flexible display screen 10 may correspond to various application operations. Specifically, when it is detected that the third part and/or the second part are unbent, a particular function or menu can be automatically performed. In one example, when the flexible display screen 10 is in the second deformation mode, the first part of the flexible display screen 10 is in a screen-locked state, and when it is detected that the second part and/or the third part is unbent, the first part is controlled to be in an unlocked state, thus avoiding other unlocking operations performed by the user, and facilitating using by the user.

In one embodiment, and in one specific implementation, involving support of the flexible display screen 10 in the unbent mode and the first deformation mode, there are two ways to implement.

A first way to implement is as follows.

In one embodiment, the main structure of the flexible display screen 10 comprises three layers: a substrate layer, a middle display medium layer, and an encapsulation layer. The substrate of the flexible display screen 10, i.e., the flexible substrate, is a base of the flexible display screen 10. Therefore, the substrate can be made of a special material, and the special material can ensure that the deformation of the flexible display screen 10 after being deformed is unchanged. For example, the material can ensure that the deformation of the flexible display screen 10 is unchanged after the application of an external force when the temperature of the flexible display screen 10 is higher than a preset temperature, such as, higher than 10 Celsius degrees, or 12 Celsius degrees, or 15 Celsius degrees. In other embodiments, the material can ensure that the deformation of the flexible display screen 10 is unchanged after being deformed by the action of an external force when the number of times of bending of the flexible display screen 10 caused by an external force is higher than a preset number, such as ten times, twelve times, or fifteen times. The material can also, in other embodiments, ensure that the deformation of the flexible display screen 10, after being deformed by the action of an external force, is unchanged in the case where the current flowing through the flexible display screen 10 is higher than a preset current and less than a rated current. Other cases are possible, and are not limited by the specific examples provided herein.

A second way to implement is as follows.

In this method of implementation, the flexible display screen 10 is supported mechanically by means of a flexible support apparatus. In one embodiment, the flexible support apparatus is arranged at a position corresponding to a variation region. The flexible support apparatus is deformed by the action of an external force to drive the variation region of the flexible display screen 10 to be deformed along with the flexible support apparatus, and the flexible support apparatus remains in the deformation state after the external force is canceled, to maintain stability of the flexible display screen 10 after being deformed.

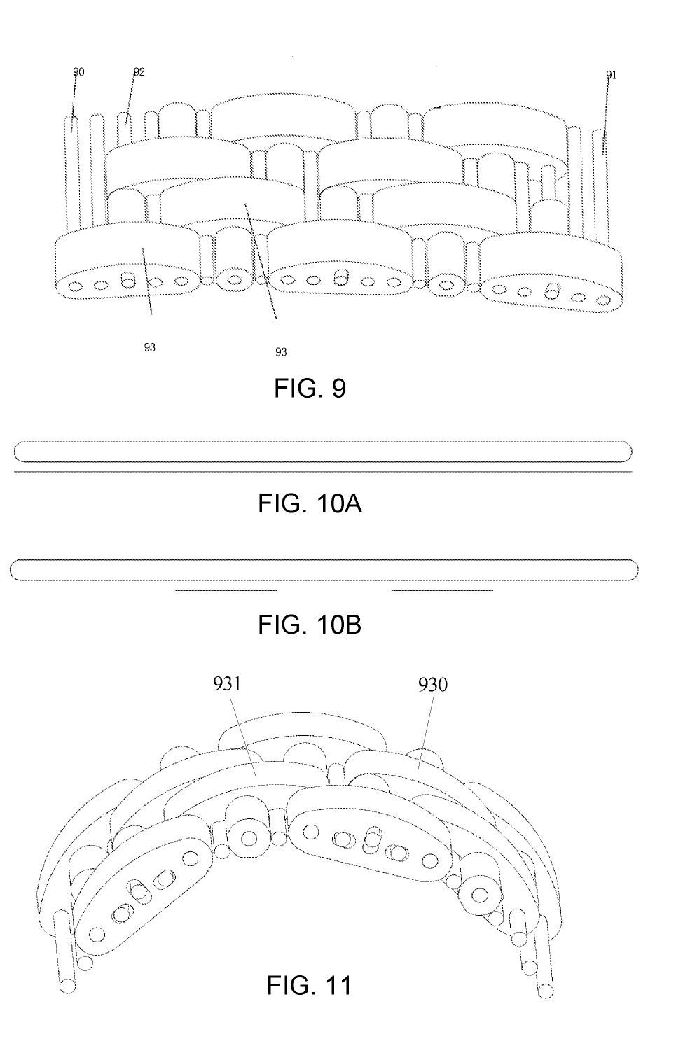

In a specific implementation, referring to FIG. 9, the flexible support apparatus includes a first sliding shaft 90, a second sliding shaft 91, a middle sliding shaft group 92 including multiple middle sliding shafts arranged in rows; and a connecting member group 93, the middle sliding shaft group being movably connected to the first sliding shaft and the second sliding shaft by the connecting member group,

Specifically, the flexible support apparatus is bendable along an extending direction of the middle sliding shaft group, and a bent portion formed after bending the flexible support apparatus is always of an arc-shaped structure.

In one embodiment, for mechanically supporting the flexible display screen 10, the flexible display screen 10 further includes a flexible support apparatus.

In a specific implementation, wherein the flexible electronic device includes a device body 80 and does not include a device body 80, the specific positions for arranging the flexible support apparatus comprise two different cases, which are specifically described hereinafter.

In a first case, the flexible electronic device does not include a device body 80. Such a case comprises two situations that depend on the position where the flexible support apparatus is arranged, which are described respectively hereinafter.

In a first situation, the flexible support apparatus is arranged on the whole surface of the second surface, corresponding to the first surface 101, of the flexible display screen 10 (FIG. 10A).

In a second situation, the flexible device is located on the second surface corresponding to the first surface 101 of the flexible display screen 10 only at positions corresponding to the first variation region and the second variation region 103 (FIG. 10B).

In a specific implementation, if the flexible electronic device can only be bent at a preset position (for example, on the first variation region and the second variation region 103 on the flexible display screen 10), then it simply requires that the flexible support apparatus be located on the second surface corresponding to the first surface 101 at positions corresponding to the first variation region and the second variation region 103.

In a second case, the flexible electronic device includes the device body 80.

In a specific implementation, when the flexible display screen 10 is located on one surface of the device body 80, the flexible support apparatus can be located on the second surface corresponding to the first surface 101, and the flexible support apparatus may also be located in an accommodating space defined by the front housing 801 and the rear housing 802. The two implementation methods can both be achieved, which can be set according to practical requirements by those skilled in the art, are not limited to the specific examples described herein.

Furthermore, in a specific implementation, in the case wherein the first part of the flexible display screen 10 is connected to the device body 80, and other parts are covered on the device body 80, the flexible support apparatus is also to be arranged on the second surface corresponding to the first surface 101.

Further, in a specific implementation, in order to ensure that the flexible display screen 10 can be bent at any position, and can be kept in any bent state, the flexible support apparatus may be located at any position on the second surface corresponding to the first surface 101 of the flexible display screen of the flexible electronic device. Of course, the flexible support apparatus may also be arranged at a preset position, such as the first variation region or the second variation region 103 on the flexible display screen 10.

In a specific implementation, whether the flexible support apparatus is arranged at any position on the second surface or the flexible support apparatus is arranged at the second surface at the positions corresponding to the first variation region and the second variation region 103, the structures of the flexible support apparatus are the same. The structure of the flexible support apparatus is described hereinafter simply by taking the flexible support apparatus arranged at positions corresponding to the first variation region and the second variation region 103 as an example.

In one embodiment, in the case where the flexible support apparatus is arranged at each of a first position corresponding to the first variation region and a second position corresponding to the second variation region 103, the corresponding flexible support apparatuses comprise a first flexible support apparatus and a second flexible support apparatus. The structure of only one of the flexible support apparatuses is illustrated hereinafter.

In a specific implementation, axes of the first sliding shaft 90, the second sliding shaft 91 and the middle sliding shaft group 92 are in parallel with each other, and the first sliding shaft 90 and the second sliding shaft 91 are located on two sides of the middle sliding shaft group 92, and the middle sliding shaft group is movably connected to the first sliding shaft 90 and the second sliding shaft 91 by the connecting member group 93. Specifically, the flexible support apparatus is bendable along an extending direction of the middle sliding shaft group, and the bent portion of the flexible support apparatus is generally of an arc-shaped structure. Reference may be made to FIGS. 11 to 12.

In one embodiment, the bent portion formed after bending the flexible support apparatus is generally of an arc-shaped structure, and the arc-shaped structure matches the variation curve, in order to support and protect the flexible deformation at a corresponding position of the flexible display screen 10.

In a specific implementation, since two ends of the connecting member group 93 are respectively sleeved on the first sliding shaft 90 and the second sliding shaft 91, a middle portion of the connecting member group is sleeved on the middle sliding shaft group 92.

Further, in a specific implementation, the connecting member group may be configured to include a double shaft toothed block sleeved on the sliding shaft group, and the sliding shafts are connected into an integral body by the double shaft toothed block, and adjacent double shaft toothed blocks are meshed to form an interference fit, thus enabling the middle sliding shafts arranged in rows in the flexible support apparatus to form an arc-shaped structure. Therefore, in a specific implementation, the bent portion formed after deforming the flexible support apparatus is generally of an arc-shaped structure, and the arc-shaped structure formed matches the variation curve, to support and protect the flexible deformation of the flexible display screen 10 at a position corresponding to the first variation region or the second variation region 103.

In one embodiment, the arc-shaped curve corresponding to the arc-shaped structure matches the variation curve corresponding to the first variation region or the second variation region. In a specific implementation, the arc-shaped curve matching the variation curve means that an opening direction of the arc-shaped curve is the same as the opening direction of the variation curve, as in FIG. 4. The direction oriented from the point E to the point F or the direction oriented from the point G to the point H, and the difference between the arc measure corresponding to the arc-shaped curve and the arc measure corresponding to the variation curve is less than a preset arc measure, for example, π/10; or π/15; π/20 or another preset arc measure, which can be set by those skilled in the art according to practical requirements, and is not limited by the specific examples described herein.

Further, in one embodiment, the bent portion includes M sliding shafts, and the arc-shaped structure of the bent portion means that an external tangent surface of the M sliding shafts is an arc-shaped surface.

In cases wherein the M sliding shafts form the arc-shaped structure, the sliding shafts at a first side of each of the M sliding shafts are stationary with respect to each other, and the sliding shafts at a second side of each of the M sliding shafts are stationary with respect to each other.

In a specific implementation, the arc-shaped structure at the bent portion refers to the arc-shaped surface formed on an external tangent surface of the M sliding shaft at the bent portion. Specifically, in the case where an arc-shaped structure is formed at a bent portion of the flexible support apparatus, a sectional surface of the arc-shaped structure at the bent portion comprises an arc-shaped surface.

In the flexible support apparatus, the sliding shafts at two sides of each of the M sliding shafts are respectively stationary in the process of the M sliding shafts forming the arc-shaped structure. Namely, portions at two sides of the bent portion of the flexible support apparatus are not deformed in the process of the M sliding shafts forming the arc-shaped structure. Thus, it is convenient for users to bend the flexible support apparatus according to practical requirements. Of course, the M sliding shafts may be configured to include the first sliding shaft 90 and part of the middle sliding shaft group 92 or to include the second sliding shaft 91 and part of the middle sliding shaft group 92. Furthermore, the M sliding shafts may be configured to include the first sliding shaft 90, the second sliding shaft 91 and the middle sliding shaft group 92, and correspondingly, the flexible support apparatus may form a C-type arc-shaped structure, and may further be rolled into a rolled-up shape, which is convenient for the users to store. To simplify the structure and facilitate assembly, the above connecting member group may also be configured to include a first connecting member 930, and a second connecting member 931.

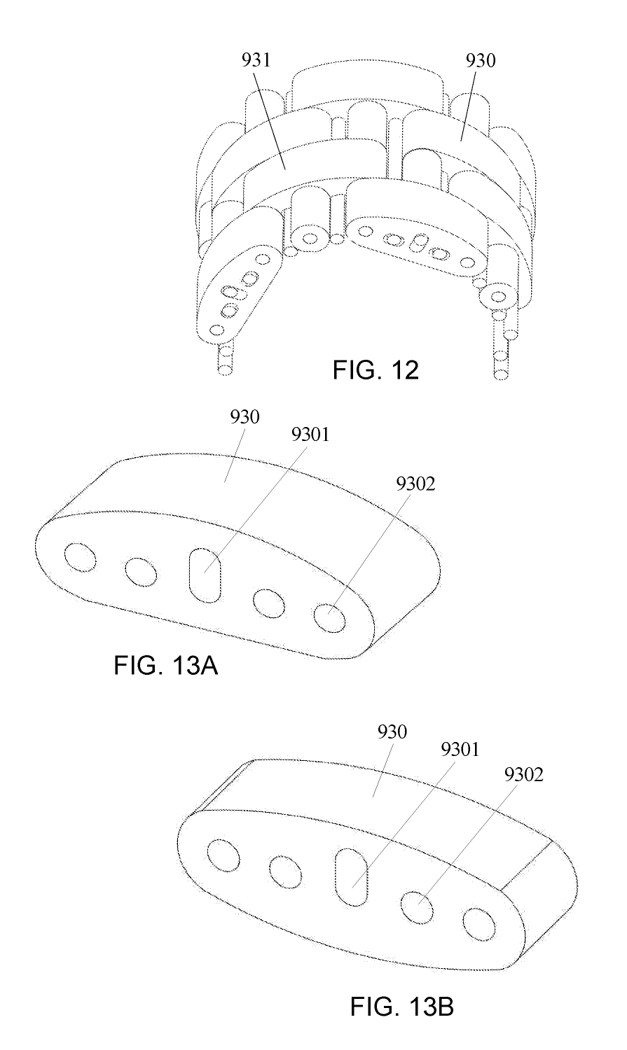

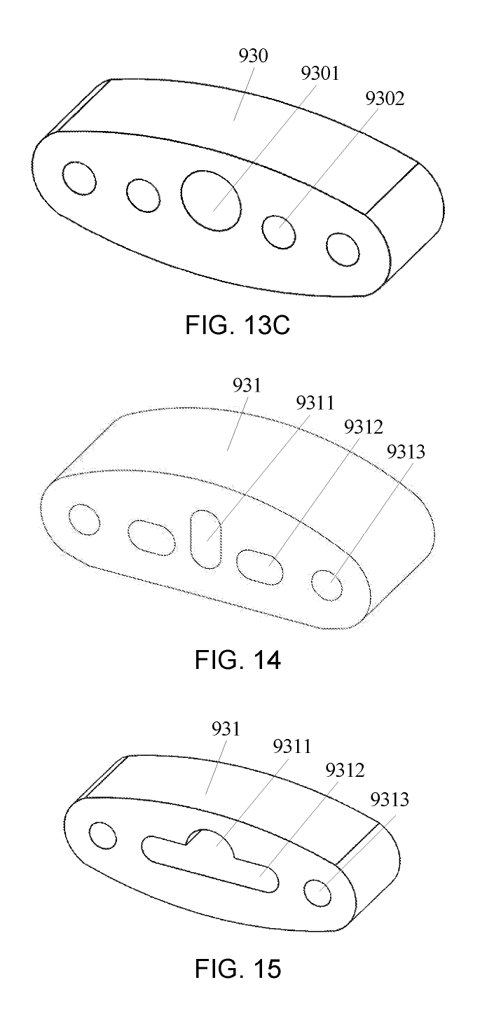

Referring to FIGS. 13A to 13C, the first connecting member 930 has five mounting holes distributed along the direction of a first straight line. Specifically, the mounting hole in the middle is a first mounting hole 9301, and the mounting holes at two sides each comprise second mounting holes 9302. The first mounting hole 9301 enables a sliding shaft in cooperation with the first mounting hole 9301 to rotate about an axis of the sliding shaft, and enables the sliding shaft to slide along a direction perpendicular to the direction of the first straight line. The second mounting hole 9302 enables a sliding shaft in cooperation with the second mounting hole 9302 to rotate about an axis of the sliding shaft.

Referring to FIG. 14, the second connecting member 931 has five mounting holes distributed along the direction of a second straight line. Specifically, the mounting hole in the middle is a third mounting hole 9311, and two mounting holes directly adjacent to the third mounting hole 9311 each comprise a fourth mounting hole 9312, and two mounting holes at two ends each comprise a fifth mounting hole 9313. The third mounting hole 9311 enables a sliding shaft in cooperation with the third mounting hole 9311 to rotate about an axis of the sliding shaft, and enables the sliding shaft to slide along a direction perpendicular to the direction of the second straight line. The fourth mounting hole 9312 enables a sliding shaft in cooperation with the fourth mounting hole to rotate about an axis of the sliding shaft, and enables the sliding shaft to slide along the direction of the second straight line. The fifth mounting hole 9313 enables the sliding shaft in cooperation with the fifth mounting hole 9313 to rotate about an axis of the sliding shaft.

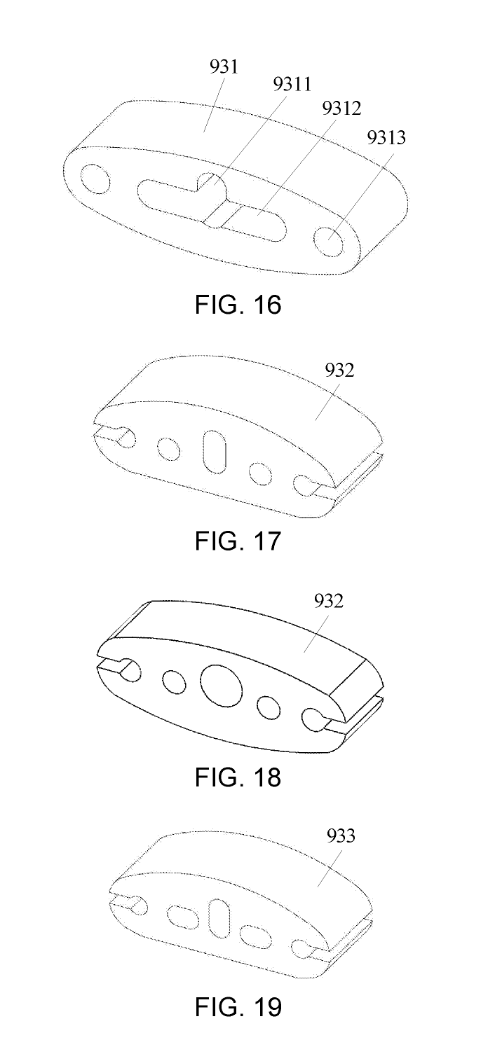

The first connecting members 930 are connected end-to-end in order along an arrangement direction of the middle sliding shaft group, and form a first connecting member group. The second connecting members 931 are connected end-to-end in order along an arrangement direction of the middle sliding shaft group, and form a second connecting member group. The first mounting hole 9301 and the corresponding fifth mounting hole 9313 are sleeved on the same sliding shaft. Being connected end-to-end as described above means that the mounting holes at ends of two adjacent connecting members are sleeved on the same sliding shaft, thus the first connecting member group and the second connecting member group each having connecting members staggered are respectively formed. Of course, to facilitate manufacturing, the third mounting hole 9311 and two fourth mounting holes 9312 may be arranged to communicate with each other (reference may be made to FIGS. 15 and 16 for specific details).

In the flexible support apparatus of this embodiment, two kinds of connecting members are respectively sleeved on the sliding shafts, which allows the M sliding shafts to form the arc-shaped structure by movements of the sliding shafts in the mounting holes and slight deformations of the sliding shafts during use. Thus the structure thereof is simple and the assembly is facilitated. In practical use, by reasonably designing the size of each of the mounting holes, the external tangent surface of the above M sliding shafts is allowed to be deformed as a circular-arc-shaped surface. Thus, user requirements can be met, and in another aspect, volume reduction of the flexible support apparatus is achieved by folding the flexible support apparatus into a u-shaped structure or a snake-shaped structure, thereby providing convenience during storage.

In the flexible support apparatus according to the above embodiment, the number of the first connecting members 930 in the first connecting member group is at least five, and the number of the second connecting members 931 in the second connecting member group is at least four, thus ensuring that the flexible support apparatus can be bent, and the bent portion is always of an arc shape in the bending process.

In a specific implementation, in the case where the flexible support apparatus is provided only at a position corresponding to the first variation region or the second variation region of the flexible display screen 10, the number of the first connecting members in the first connecting member group may be five, and the number of the second connecting members 931 in the second connecting member group may be four.

In the case where the flexible support apparatus is provided at any position on the second surface corresponding to the first surface 101 of the flexible display screen 10, the number of the first connecting members in the first connecting member group and the number of the second connecting members in the second connecting member group are required to be provided according to the specific dimension of the flexible display screen 10. In one specific example, the number of the first connecting members in the first connecting member group is ten and the number of the second connecting members in the second connecting member group is eight. In other examples, the number of the first connecting members in the first connecting member group is fifteen and the number of the second connecting members in the second connecting member group is 12, and so on and so forth. Various configurations can be set according to the specific dimension of the flexible display screen 10, and the configurations are not limited to the specific examples given herein.

The above flexible support apparatus may be configured to be bendable along only one side. Correspondingly, one edge of the first mounting hole 9301 extends beyond one side of the first straight line, and another edge of the first mounting hole 9301 is leveled with an edge portion of the second mounting hole 9302; and one edge of the third mounting hole 9311 extends beyond one side of the second straight line, and another edge of the third mounting hole 9311 is leveled with an edge portion of the fourth mounting hole 9312 and an edge portion of the fifth mounting hole 9313. Also, extending directions of the first mounting hole 9301 and the third mounting hole 9311 are toward the same side of the flexible support apparatus. The flexible support apparatus of this embodiment can only be bent from a straight state toward one side of the flexible support apparatus, thus can prevent a device supported by the flexible support apparatus, such as a flexible screen, from being reversely bent and prevent the device such as the above flexible screen from being damaged.

Of course, the flexible support apparatus may further be configured to be bendable towards two sides according to practical requirements, and, correspondingly, in such an embodiment, two edges of the first mounting hole 9301 respectively extend beyond two sides of the first straight line, and two edges of the third mounting hole 9311 respectively extend beyond two sides of the second straight line. Bending directions of the flexible support apparatus are not limited in this embodiment, and the bending direction may be set just by adjusting the extending directions of the first mounting hole 9301 and the third mounting hole 9311 according to practical requirements. In addition, a bending degree of the flexible support apparatus may be adjusted by adjusting lengths of the first mounting hole 9301 and the third mounting hole 9311 according to practical requirements.

The flexible display screen 10 supported by the flexible support apparatus is usually required to remain in a fixed state during application, thus the flexible support apparatus of the above embodiment is preferably configured to be capable of remaining in any bent state.

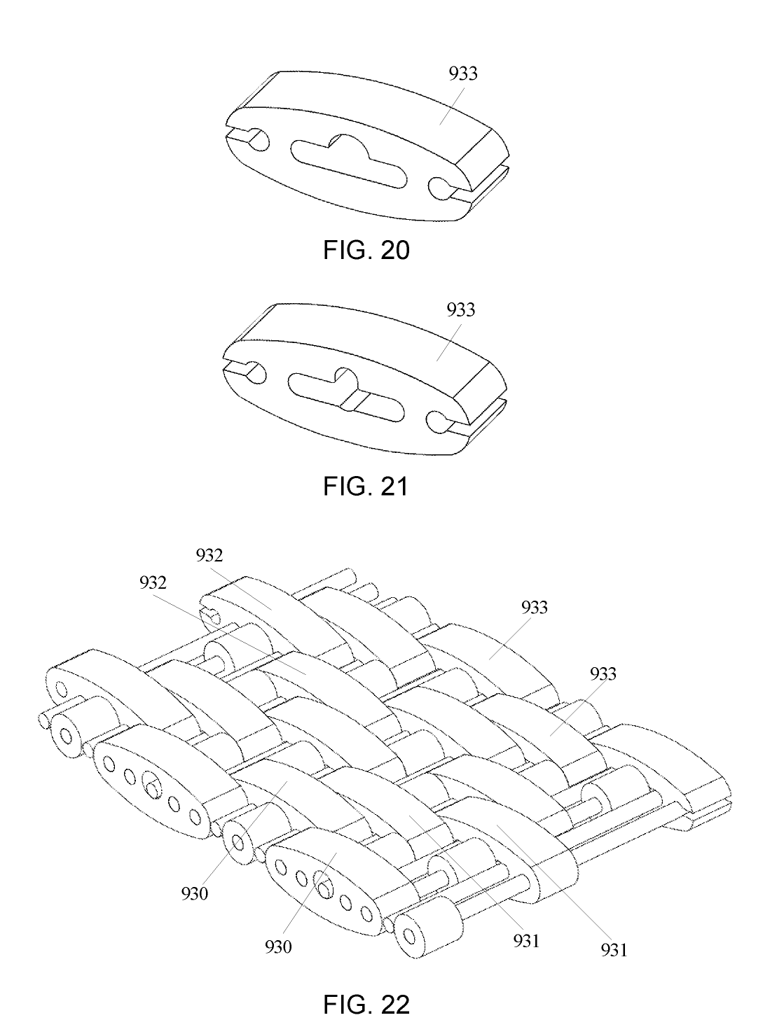

Specifically, the above flexible support apparatus may remain in any bent state through an additional member as provided. For example, in some embodiments, the connecting member group is configured to further include a third connecting member 932 and a fourth connecting member 933 (reference may be made to FIGS. 17 to 21 for specific details). The third connecting members 932 have the same structure and arrangement as the first connecting members 930, and each of the third connecting members 932 and the corresponding first connecting member 930 are sleeved on the same sliding shaft. The fourth connecting members 933 have the same structure and arrangement as the second connecting members 931, and each of the fourth connecting members 933 and the corresponding second connecting member 931 are sleeved on the same sliding shaft. The two second mounting holes 9302 located on two ends of each of the third connecting members 932 can provide a rotation damping to the sliding shafts corresponding to the two second mounting holes 9302 respectively. The fifth mounting holes 9313 of each of the fourth connecting members 933 can provide a rotation damping to the sliding shafts corresponding to the fifth mounting holes 9313 respectively. The two second mounting holes 9302 located on two ends of each of the third connecting members 932, and the fifth mounting holes 9313 of each of the fourth connecting members 933 can be respectively configured as a hole with opening, which not only facilitates the assembly with the mounting holes, but also may allow the above two kinds of mounting holes to provide the rotation damping to the corresponding sliding shafts through an interference fit (reference may be made to FIG. 22 for specific details).

Of course, to reduce the number of connecting members and simplifying assembly and operation, the flexible support apparatus according to the above embodiment may be further configured in such a way that the second mounting holes 9302 located on two ends of the first connecting member and the fifth mounting holes 9313 of the second connecting member are each configured as a mounting hole capable of providing a rotation damping to the corresponding sliding shaft, to enable the flexible support apparatus to remain in any bent state. Specifically, a friction pad for closely cooperating with the sliding shaft, such as a rubber pad, may be fixed in the mounting hole.

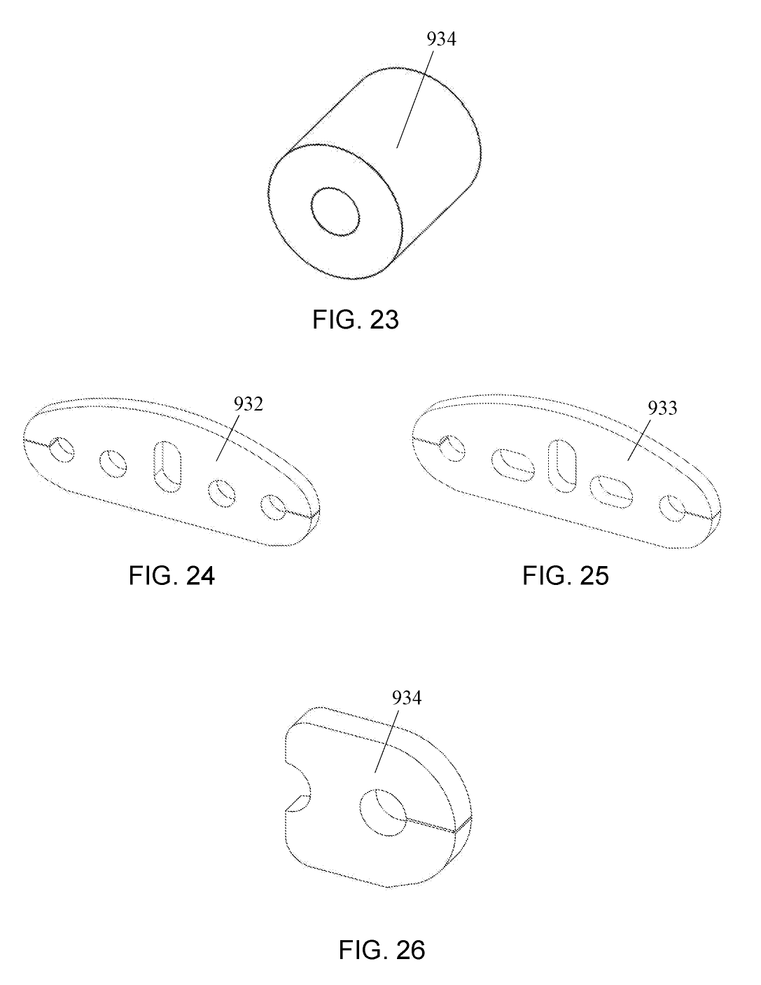

In the above flexible support apparatus, the connecting members in the connecting member group are all staggered. Therefore, there are many clearances, which are apt to cause damage to the device supported by the flexible support apparatus in the case where the device receives an external force. Therefore, the flexible support apparatus of the above embodiment further includes a filling block 934 (reference may be made to FIG. 23 for specific details). The filling block 934 is sleeved on the sliding shaft, and is located between two connecting members spaced apart from each other in the connecting member group. Three sliding shafts are arranged between the two connecting members spaced apart from each other in the above connecting member group, and, to avoid an interference in relative movements of the three sliding shafts, the above filling block 934 is only sleeved on one of the three sliding shafts. Of course, in different embodiments, any two of the three sliding shafts may be each provided with the filling block 934, or the three sliding shafts may be each provided with the filling block 934.

Preferably, one side of the flexible support apparatus of the above embodiment is flat when the flexible support apparatus is unbent, which facilitates the arrangement of the flexible screen. The flexible support apparatus may adopt the first connecting member 930 in FIG. 13A, the second connecting member 931 in FIG. 14, the third connecting member 932 in FIG. 17, and the fourth connecting member 933 in FIG. 19.

In some embodiments of the above flexible support apparatus, the first connecting member 930 and the second connecting member 931 may be respectively configured to have a block-like structure, and correspondingly, the third connecting member 932, the fourth connecting member 933, and the filling block 934 may also be configured to have the block-like structure. The first connecting member 930 and the second connecting member 931 may further be each configured to be of a sheet-like structure which can be conveniently manufactured by stamping, and correspondingly, the third connecting member 932, the fourth connecting member 933, and the filling block 934 are of the structures which can be conveniently manufactured by stamping as shown in FIGS. 24, 25, and 26 respectively.

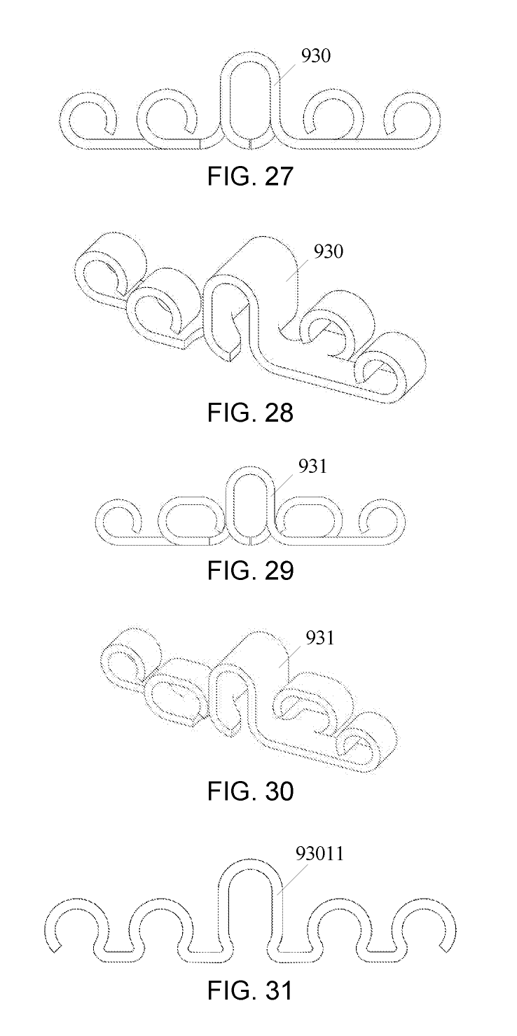

In some embodiments, to reduce the size of the flexible support apparatus, the above first connecting member 930 and the second connecting member 931 may further be configured to be of the structures in FIGS. 27 to 30, and the first connecting member 930 and the second connecting member 931 can be respectively manufactured with a steel sheet by stamping, bending and curling, to allow the mounting holes to be encircled by curled edges, and allow the curled edges of the second mounting holes 9302 located on two ends of the first connecting member 930 and the fifth mounting holes 9313 of the second connecting member 931 to tightly hold the sliding shafts to provide the rotation damping to the sliding shafts.

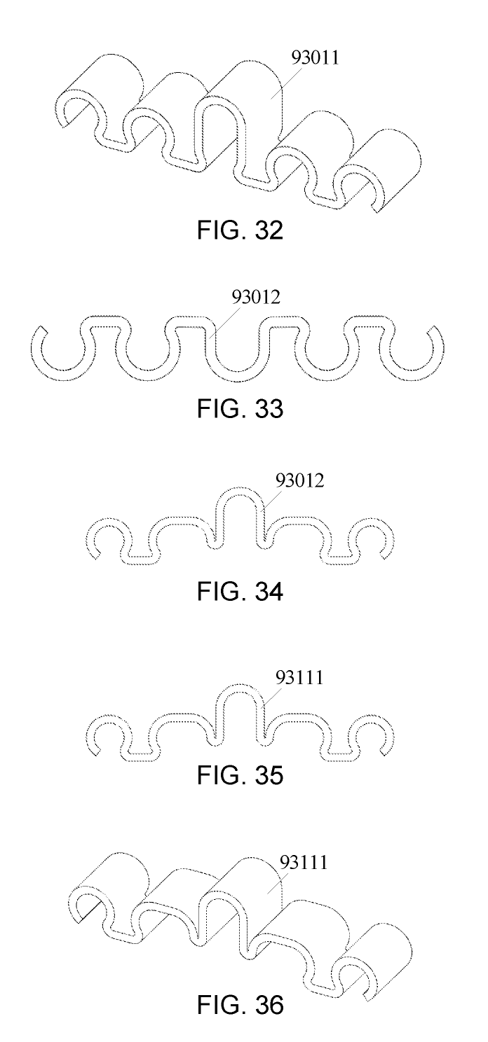

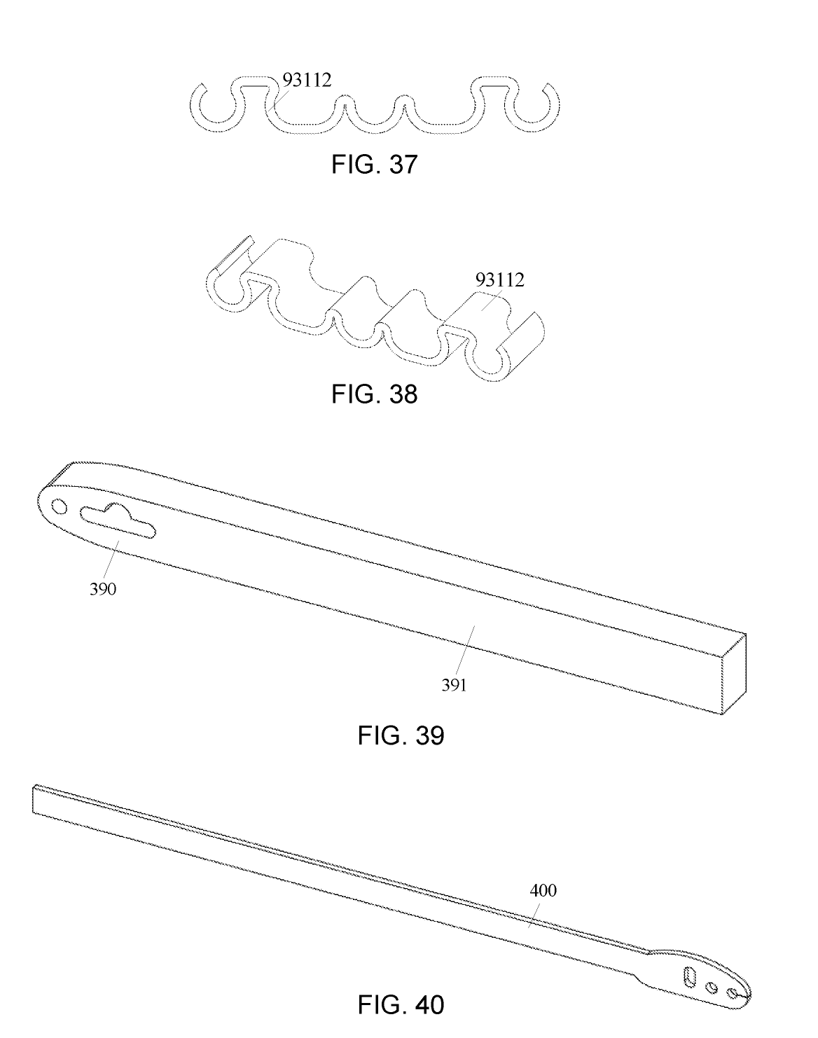

Furthermore, in some embodiments, in order to bypass the curling procedure and facilitate production and manufacturing, the first connecting member 930 in the above flexible support apparatus may be further configured to include a first member portion 93011 and a second member portion 93012, and the two member portions can be respectively sleeved on the same sliding shaft and form the first mounting hole 9301 and the second mounting hole 9302 together, as shown in FIGS. 31 to 38. Correspondingly, the second connecting member 931 is configured to include a third member portion 93111 and a fourth member portion 93112, and the two member portions are respectively sleeved on the same sliding shaft and form the third mounting hole 9311, the fourth mounting hole 9312 and the fifth mounting holes 9313 together. The flexible support apparatus of this embodiment can be manufactured to have an overall thickness of only 1.2 mm.

In a specific implementation, whether the flexible display screen is arranged on the second surface corresponding to the first surface 101 of the flexible display screen 10 or arranged in the accommodating space defined by the front housing 801 and the rear housing 802 of the device body 80, a first fixed connection piece fixedly connected to the flexible display screen 10 or the device body 80 is generally needed (reference may be made to FIG. 39). The first fixed connection piece includes a mounting handle 391 and a mounting portion 390 fixedly connected to the mounting handle. The mounting portion 390 is provided with mounting holes, and the mounting portion is configured to be sleeved on the first sliding shaft 90 and the middle sliding shaft group 92 adjacent to the first sliding shaft 90. Alternatively it is configured to be sleeved on the second sliding shaft 91 and the middle sliding shaft group 92 adjacent to the second sliding shaft 91. According to the practical arrangement of the first connecting members 930 and the second connecting members 931 in the flexible support apparatus, the above mounting holes may be configured to be the same as the mounting holes in the first connecting member 930, or the same as the mounting holes in the second connecting member 931. Alternatively, the above mounting holes may also be configured to only include three mounting holes, and, in such a case, the three mounting holes are respectively the same as the first mounting hole 9301 and the two second mounting holes 9302 located on the same side of the first mounting hole. In yet another alternative implementation, the three mounting holes are respectively the same as the third mounting hole 9311 and the fourth mounting hole 9312 and the fifth mounting hole 9313 located on the same side of the third mounting hole 9311. The number and structure of the mounting holes in the mounting portion are not limited to the specific examples herein; however, it should be ensured that the flexible support apparatus can be normally deformed when the mounting portion is sleeved on the sliding shafts.

Further, the above flexible support apparatus further includes a second fixed connection piece 400, referring to FIG. 40, that has the same structure as the first fixed connection piece, and a mounting hole of its mounting portion at an end is a hole with an opening, configured to have an interference fit with a sliding shaft corresponding to the mounting hole.

In one embodiment, wherein the flexible electronic device includes the device body 80, it may also comprise a movable support in the accommodating space defined by the front housing 801 and the rear housing 802 of the device body 80 that mechanically supports the flexible display screen 10. In one embodiment, the movable support may be made of a metal material or other solid materials, such as plastic. In a specific implementation, a spring material may be adopted to make the support, in order to enhance the feeling in the hand for the user. In a specific implementation, when the flexible display screen 10 is in the unbent mode, the support can slide out along a horizontal direction, and an upper surface of the support abuts against the second surface, corresponding to the first surface 101, of the flexible display screen 10, to keep the flexible display screen 10 in the unbent mode.

By means of the one or more technical solutions in the embodiments of the application, the following one or more technical effects can be achieved.

First, a technical solution in one embodiment includes a flexible display screen including a first surface which is a display output region of the flexible display screen. Specifically, the flexible display screen generates a deformation of a first variation curve at a first variation region by the action of an external force, to allow two display regions of the flexible display screen partitioned by the first variation region to face each other, and a deformation state in which the flexible display screen has the deformation of the first variation curve is kept unchanged after the external force is canceled. The flexible display screen generates a deformation of a second variation curve at a second variation region by the action of an external force, to allow two display regions of the flexible display screen partitioned by the second variation region to face away from each other, and a deformation state in which the flexible display screen has the deformation of the second variation curve is kept unchanged after the external force is canceled. Thus, unlike in the conventional technology wherein a flexible display screen of an electronic device can only be bent in a simple manner, such as inwards or bent outwards, there are limited manners by which the device can be bent. In this technical solution, the deformation of the first variation curve can be generated on the first variation region, to allow the two display regions of the flexible display screen partitioned by the first variation region to face each other, or the flexible display screen generates a deformation of the second variation curve on the second variation region by the action of an external force to allow the two display regions of the flexible display screen partitioned by the second variation region to face away from each other, thus providing enriched manners of bending. Therefore the technical issue of the restrictions on manners of bending in the flexible display screen of the electronic device in the conventional technology can be effectively addressed, and the technical effect of providing more ways of bending can then be achieved.

Second, in a technical solution according to one embodiment, the first variation region is not fixed, and the second variation region is not fixed. That is, in this technical solution, the first variation region and the second variation region of the flexible display screen are not fixed, but vary along with the point where an external force is applied. Hence, the user of the electronic device may bend the flexible electronic device according to actual needs, and may bend in various ways, thus achieving the technical effect of improving the experience of the user.

Third, in a technical solution according to one embodiment, a flexible support apparatus is provided at least at a position corresponding to a variation region. The flexible support apparatus is deformed by the action of an external force to drive the variation region of the flexible display screen to be deformed along with the flexible support apparatus, and the flexible support apparatus remains in the deformation state after the external force is canceled to maintain stability of the flexible display screen after being deformed. That is, in this technical solution, with the flexible support apparatus, the second part and the third part of the flexible display screen are mechanically supported to allow the user to better operate the flexible electronic device, thus achieving the technical effect of improving the user experience.

Fourth, a technical solution of one embodiment further includes a processor, and the processor is configured to acquire mode information of the flexible display screen, and the display of to-be-displayed contents on the three regions and/or the variation regions of the flexible display screen are determined according to the mode information of the flexible display screen. That is, in this technical solution, the mode information of the flexible display screen is acquired by the processor, and the display of the to-be-displayed contents currently in the three regions and/or the variation regions are determined according to the mode that the flexible display screen is currently in, thus allowing the display manner of the to-be-displayed contents to better comply with the requirements of the user, and to improve user experience.

While preferred embodiments have been described, variations and modifications may be made to these embodiments once the basic inventive concept is obtained by those skilled in the art. Thus, the attached claims are intended to be explained as including the preferred embodiments and all variations and modifications that fall within the scope of the this disclosure.

It is clear that various variations and modifications to the embodiments may be made by those skilled in the art without departing from the spirit and scope of the embodiments. Accordingly, if these variations and modifications to the embodiments fall within the scope of the claims and the equivalents thereof, it is also intended that this disclosure encompass these variations and modifications.

What is claimed is:

1. A device, comprising:
a flexible display screen comprising a plurality of display regions at a first surface;
the flexible display screen comprising a deformable first variation region to orientate a first display region to face towards a second display region; and
the flexible display screen further comprising a deformable second variation region to orientate a third display region to face away from the second display region.

2. The device of claim 1, wherein
the first variation region is distinct from the second variation region.

3. The device of claim 2, wherein
the part of the flexible display screen corresponding to the first display region comprises a first part, the part of the flexible display screen corresponding to the second display region is a second part, and the part of the flexible display screen corresponding to the third display region is a third part; and
the first part is located on a first side of a plane where the second part is located, and the third part is located on a second side, opposite to the first side, of the plane where the second part is located.

4. The device of claim 1, further comprising:
a flexible support apparatus,
wherein
the flexible support apparatus is located at a position corresponding to one of the first and second variation regions; and
the flexible support apparatus is deformed by an external force to drive the variation region of the flexible display screen to be deformed along with the flexible support apparatus.

5. The device of claim 4, wherein
a bent portion formed after bending the flexible support apparatus is of an arc-shaped structure; and
the arc-shaped structure supports and protects a flexible deformation of the flexible display screen at a corresponding position.

6. The device of claim 5, wherein
the flexible support apparatus comprises:
a first sliding shaft,
a second sliding shaft,
a middle sliding shaft group, comprising a plurality of middle sliding shafts arranged in rows, and
a connecting member group that movably couples the middle sliding shaft group to the first sliding shaft and the second sliding shaft; and
the flexible support apparatus is bendable along an extending direction of the middle sliding shaft group, and the bent portion of the flexible support apparatus is always of an arc-shaped structure.

7. The device of claim 6, wherein
the bent portion comprises a plurality of sliding shafts; and
the arc-shaped structure of the bent portion comprises an arc-shaped surface.

8. The device of claim 7, wherein
while the plurality of sliding shafts form the arc-shaped structure,
sliding shafts at a first side of each of the plurality of sliding shafts are stationary with respect to each other, and
sliding shafts at a second side of each of the plurality of sliding shafts are stationary with respect to each other.

9. The device of claim 1, wherein
the flexible display screen can be placed into a planar mode and a first deformation mode.

10. The device of claim 1, further comprising:
a device body;
wherein
the first part of the flexible display screen is coupled to the device body, and
the flexible display screen can be placed into a second deformation mode in which the flexible display screen is deformed at least partially around the device body.

11. The device of claim 1, further comprising:
a processor;
wherein
the processor acquires mode information of the flexible display screen, and determines information to be displayed on the flexible display screen based on the mode information of the flexible display screen.

12. The device of claim 1, wherein
either or both of the first and second variation regions are not fixed.

13. A method, comprising:
providing a flexible display screen comprising a plurality of display regions at a first surface;
deforming a first variation region of the flexible display screen to orientate a first display region to face towards a second display region; and
deforming a second variation region of the flexible display screen to orientate a third display region to face away from the second display region.
